(19) United States
(12) Patent Application Publication
(10) Pub. No.: US 2008/0241723 A1
(43) Pub. Date: Oct. 2, 2008

(54) EMULSION AGGREGATION TONER COMPOSITIONS HAVING CERAMIC PIGMENTS

(75) Inventors: Grazyna E. KMIECIK-LAWRYNOWICZ, Fairport, NY (US); Maura A. SWEENEY, Irondequoit, NY (US); Robert D. BAYLEY, Fairport, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/691,201

(22) Filed: Mar. 26, 2007

(51) Int. Cl. G03G 9/08; G03G 5/00

(52) U.S. Cl. 430/107.1; 430/108.1; 430/108.22; 430/108.4; 430/109.3; 430/109.4; 430/111.4; 430/137.14

(57) ABSTRACT

Emulsion aggregation toner particles comprising at least one binder resin and a colorant, wherein the colorant comprises at least one ceramic pigment.

### BACKGROUND

Described herein is an emulsion aggregation toner composition comprising a colorant comprised of at least one ceramic pigment. Such toner compositions exhibit improved wide color space/gamut, heat stability and lightfastness stability. The toner composition is also useable in new applications unsuitable for current xerographic toners, for example for use in coloring ceramic materials that undergo a firing process.

### REFERENCES

U.S. Patent Application Publication No. 2003-0207041 discloses a transfer material containing an inorganic pigment, or hot melt ink containing an inorganic pigment that is directly or indirectly disposed on the surface of a ceramic body in an imagewise manner. Subsequently, the ceramic body with the image formed thereon is heated and the inorganic pigment contained in the image is sintered on the surface of the ceramic body.

U.S. Patent Application Publication No. 2001-0031415 discloses an inorganic toner composition providing a chromatic color upon being calcined and comprising an inorganic coloring agent, and a binder resin, wherein the content of coarse particles having a diameter of 16 μm or more in said inorganic toner is not greater than 20% by weight. The toner is obtained by kneading a mixture containing an inorganic coloring agent and a binder resin, coarsely pulverizing the kneaded mixture such that the pulverized mixture has a volume average particle diameter of 20-150 μm, finely pulverizing the coarsely pulverized mixture, and sieving the ground mixture.

U.S. Pat. No. 6,248,492 discloses an electrostatic method for producing a master image for decorating ceramic, enamel or glass objects comprising the steps of: providing a temporary support having a surface with release properties, image-wise depositing charged toner particles, having a volume average particle size dᵥ, such that 5 μm<dᵥ<15 μm the particles including in the bulk particles of a ceramic pigment, CP, selected from the group of metals, metal oxides and mixed metal oxides, having a volumetric particle size distribution such that 90% of the particles have a diameter lower than ⅔ times dᵥ and providing particles of glazing material, having a volumetric particle size distribution such that 90% of the particles have a diameter lower than ⅔ dᵥ, in the master image. Preferably the glazing material is brought in the master image by image-wise depositing toner particles comprising in the bulk of the toner particles both a ceramic pigment and glazing material.

U.S. Pat. No. 7,018,760 discloses a ceramic toner that is transferable to a high-temperature resistant glass, glass ceramic or ceramic substrate by electrophotographic printing and that can be fired in a subsequent temperature process, containing color pigment particles in addition to special glass flow particles. According to this invention, the ceramic toner has a thermoplastic synthetic matrix which melts in a homogeneous manner on the substrate within a temperature range of 100° C.-400° C. and that, within the temperature range of 300° C.-500° C., vaporizes in an almost residue-free manner and/or decomposes in order to obtain a toner that can be transferred especially in a direct printing mode and that has almost no synthetic matrix residue after firing.

U.S. Pat. No. 6,110,632 discloses electrostatic printing toner particles comprising 71 to 90 weight percent of inorganic ceramic color and 29 to 10 weight percent of an organic polymeric material. A two-part developer comprising a carrier and the ceramic toner is characterized in that the ceramic toner is present in an amount of about 2 to 24 weight percent of the developer and the toner comprises 50 to 85 weight percent of the inorganic ceramic color and 50 to 15 weight percent of polymeric material. Typically, the ceramic color comprises a ceramic pigment and a glass frit.

U.S. Pat. No. 6,487,386 discloses a device for applying decorations and characters on glass, glass ceramic or ceramic products includes an image roller provided with an electrostatically chargeable photoconductive layer; a photo-exposure assembly for generating an electrostatic charge image corresponding to at least one of decorations and characters to be applied; a supply container for a toner with a device for developing the electrostatic charge image with the toner; a dimensionally stable transfer roller for receiving the toner image, that is in direct contact with the image roller on one side and with the product on its other side; at least two coronas including a first corona arranged on the transfer roller and a second corona arranged under the product near the transfer roller and a heater for burning the toner image onto the product, after electrostatically transferring the toner image to the product by means of the coronas.

U.S. Pat. No. 6,300,030 discloses a method of making a design and/or sign on glass, glass-ceramic and ceramic articles using a transfer agent includes providing a band-shaped carrier coated with a transfer agent; periodically advancing the band-shaped carrier coated with the transfer agent past a printing station; periodically printing the design and/or sign to be applied on the transfer-agent-coated band-shaped carrier with a heat-resistant toner to form respective printed toner images in succession on the band-shaped carrier in the printing station and registering reliably and periodically transferring the respective printed toner images to corresponding glass, glass-ceramic or ceramic articles by releasing the transfer agent from the band-shaped carrier.

Emulsion aggregation toners are typically made to include inorganic or organic colorants (pigments and/or dyes) that may fade over time and when exposed to light. Documents printed with the emulsion aggregation toner may lack archival qualities when said colorants are used.

Known pigments suitable for use in emulsion aggregation toners also cannot withstand high temperatures involved in the firing of ceramics, such as plates and tiles, and thus current emulsion aggregation toners are not suitable for use in coloring ceramics that are to be fired.

### SUMMARY

In embodiments, disclosed is an emulsion aggregation toner particle comprising at least one binder and a colorant, wherein the colorant includes at least one ceramic pigment.

In further embodiments, disclosed is a process for making an emulsion aggregation toner particle, comprising mixing a resin, a colorant, and a coagulating agent, aggregating particles to a size from about 3 to about 20 microns, halting the aggregation of the particles, and coalescing the particles, wherein the colorant comprises at least one ceramic pigment.

In yet further embodiments, disclosed is a method, comprising applying a toner image composed of emulsion aggregation toner particles onto a ceramic substrate, firing the ceramic substrate in order to permanently affix the toner image thereon, wherein the emulsion aggregation toner particles comprise at least one binder and a colorant, and wherein the colorant includes at least one ceramic pigment.

### EMBODIMENTS

A potential shortfall of pigment-based toners, and specifically polymer-based styrene/butylacrylate and polyester emulsion aggregation (EA) toners, for use in ceramic work is that the toners may not be able to produce sufficient heat, chemical and lightfastness stability to enable use in ceramic applications.

Disclosed herein are EA toners that utilize one or more ceramic pigments as the colorant of the toner.

Ceramic pigments are complex inorganic pigments typically made from single or mixed metal oxides synthesized at molten metal temperatures. In embodiments, ceramic pigments are derived from divalent metals, such as iron oxide, zinc oxide, manganese oxide, chrome oxide, or trivalent metals, such as aluminum oxide, chromium oxide, iron II oxide etc. These pigments are highly color-stable, offering resistance to light, heat, chemical attack and higher solar reflectance. This assures long-term color retention and brighter, more vibrant colors over time. The ceramic pigments disclosed herein are also non-toxic and environmentally friendly.

EA toner particles containing the ceramic pigment as a colorant may be employed in electrophotographic printing, lithography, facsimile machines, xerographic printing and the like. Key attributes include excellent pigment dispersion, print resolution, and enhanced color gamut.

In further embodiments, the EA toner particles containing the ceramic pigments can be used in customized decals or labels (hereinafter collectively “decals”), which decals may be applied to a ceramic substrate prior to heating, such as firing the ceramic substrate in a kiln. Examples of ceramic substrates include plates, tiles, pottery and the like. In alternative embodiments, the EA toner particles containing the ceramic pigments, for example in the form of a liquid toner, may be directly transferred to a substrate. However, as a decal may be readily printed using a known printer or xerographic device, the use of decals may be more convenient than direct to ceramic printing.

A decal may be any substrate that may be used for transfer of an image provided that it has decent release properties. Typical decals range from paper with a coating such as a wax, an organic polymer such as polyethylene or an inorganic polymer such as silicone. In addition to paper, decals can be made of polymers such as polyethylene, polyethylene terephthalate, polyester, polyamides, cellulose acetates, polycarbonates, polyimides, etc. Decals may include a layer that is used for release of the image such as a wax or other release agent, and another layer of polymeric glue over the printed image.

For example, as described in U.S. Pat. No. 6,369,843, which is incorporated herein in its entirety by reference, disclosed is a decal or transfer sheet having a carrier sheet or sheet of support material. The carrier sheet may be made from, for example, a sheet of paper or a heat-resistant plastic sheet coated with a thin release layer of silicone or polyolefin. A layer or multiple layers of the toner particles described herein are transferred onto the carrier sheet having the release layer thereon to form a toner image. A heat activatable thermoplastic polymeric glue layer may then be applied over the formed toner image. Any pattern or image formed by the toner particles may desirably be printed in mirror-inverted fashion on the carrier sheet in order that text and images are viewable on transfer of the image to the final ceramic substrate.

The EA toner particles include at least a binder resin and a colorant. In embodiments, the binder may be a polyester resin or a styrene/acrylate resin.

Examples of ceramic pigments suitable for use herein include the primary subtractive and additive colors of cyan, magenta, yellow, blue, red, green, white and black, such as Black 444, Blue 385, Violet 11, Yellow 10P110, and combinations thereof. Additional examples of ceramic pigments suitable for used herein include spinel black, iron oxide/Mars Black 318, Iron Oxide Black Bluish 306, Iron Oxide Black Brownish 320, iron glimmer gray, manganese violet, zirconium cerulean blue, cobalt blue (dark, medium, pale blue and light), cobalt cerulean blue, cobalt blue greenish, cobalt turquoise, cobalt violet, cobalt green, cobalt oxide green, cobalt bottle green, cobalt light green, chrome oxide green, Mars Red light 110, Mars Red Medium 120, Mars Red 130, Mars Red 222, Indian Red, Spanish Red, titanium orange, lead-tin yellow, Priderite Yellow, nickel titanium yellow, Praseodym Yellow, cobalt yellow, intensive yellow, bismuth yellow, titanium white, and the like. Such ceramic pigments are available from BASF, Engelhard Complex Inorganic Color Pigments, Kremer Pigments, Hangzhou Union Pigment Corporation, Chaozhou BOI Ceramic Pigment Co., Ltd., Keeling and Walker Limited (ceramic pigments in U.S. Pat. No. 4,047,970), and Altair Technologies.

In embodiments, the ceramic pigments are composed of metal oxides such as chrome oxide, zinc oxide, alumina oxide, copper oxide, cobalt oxide and other known metallic oxides and salts, and combinations thereof The ceramic pigments may have a crystal structure that is spinel, sphene, pyrochlore, rutile, priderite, phosphate, phenacite, periclase, olivine, baddeleyite, borate, conundrum, or zircon; sulfide such as cadmium yellow; cadmium selenide compound such as selenium ruby, and the like. In addition, inorganic pigments such as phosphor or fluorescent pigment may also be suitable for use herein. These materials may be used alone or may be used in a combination of two or more.

Black 44 is a jet black powder, which may be used as a ceramic pigment, is produced by high temperature calcination, has excellent UV and visible opacity, is chemically inert, heat resistant, stable to UV light, and is non-bleeding and non-migratory. It has exceptional durability and hiding power, and is generally used in applications where the absence of chromium is desired, and resistance to heat, light and weather are desired.

High temperature calcination or calcinations as described herein is carried out in furnaces or reactors (sometimes referred to as kilns) of various designs including shaft furnaces, rotary kilns, multiple hearth furnaces, and fluidized bed reactors. The material being calcined is heated at a very high temperature to drive off water and volatiles. It is normally done below the melting point of the desired material causing loss of moisture, reduction, or oxidation and the decomposition of carbonates and other compounds. Calcinations produce materials having exceptional durability and is generally used in applications where resistance to heat, light and weather are needed.

Blue 385, which may be used as a ceramic pigment, is a rich blue powder produced by high temperature calcination, has fair UV and visible opacity, is chemically inert, heat resistant, stable to UV light, and is non-bleeding and non-migratory.

Violet 11, also known as Pigment Violet 16 or manganese violet, which may be used as a ceramic pigment, is a red-violet powder produced by high temperature precipitation, which is generally used in toning clear and white resins to mask yellowing, and as a colorant for cosmetics and external use drugs. The color additive manganese violet is a violet pigment obtained by reacting phosphoric acid, ammonium dihydrogen orthophosphate, and manganese dioxide at temperatures above 450° F. The formed pigment is a manganese ammonium pyrophosphate [(NH₄)₄Mn₂(P₂O₇)₂) As used herein, “high temperature precipitation” refers to a solution, such as phosphoric acid, ammonium dihydrogen orthophosphate, or manganese dioxide, that may be used to make the manganese violet pigment become solid at high temperatures, and then precipitating out. This precipitate is then washed, dried and ground further to produce the desired sized pigment. The pigment is non-bleeding and non-migratory, and has fair heat stability but poor to moderate exterior durability.

Yellow 10P110, which may be used as a ceramic pigment, is a bright yellow powder by high temperature calcination, has excellent UV and visible opacity, is chemically inert, heat resistant, stable to UV light, and is non-bleeding and non-migratory. The powder also has exceptional durability and hiding power, and is generally used in applications where resistance to heat, light and weather are needed.

The pigments are present in the toner particles disclosed herein in amounts of from about of from about 2 weight percent to about 18 weight percent, such as from about 3 weight percent to about 15 weight percent or from about 4 weight percent to about 13 weight percent, of the toner particles disclosed herein.

The pigments disclosed herein may be characterized as nanoscale. Nanoscale refers to, for example, having an average size (diameter) of about 200 nm or less, such as from about 0.1 nm to about 150 nm or about 1 nm to about 100 nm.

The ceramic pigments disclosed herein are incorporated into the EA toner process as the colorant for the toner. As understood by one of ordinary skill, pigments may be predispersed in a surfactant or resin binder to facilitate mixing. In embodiments, the pigments may be ground and surface modified for easier dispersal in water or other solvent. Examples of surface modifications include functionalizing the surface of the pigments by inclusion of, for example, hydrophilic functional groups, such as carboxyl groups, sulfonic acids, amines, amine salts, phosphonic salts and the like.

In embodiments, suitable binders for EA toner particles include a polymeric resin, such as a polyester resin or a styrene/acrylate resin.

Examples of suitable polyester resin binders include polyethylene-terephthalate, polypropylene-terephthalate, polybutylene-terephthalate, polypentylene-terephthalate, polyhexalene-terephthalate, polyheptadene-terephthalate, polyoctalene-terephthalate, polyethylene-sebacate, polypropylene sebacate, polybutylene-sebacate, polyethylene-adipate, polypropylene-adipate, polybutylene-adipate, polypentylene-adipate, polyhexalene-adipate, polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate polyethylene-pimelate, polypropylene-pimelate, polybutylene-pimelate, polypentylene-pimelate, polyhexalene-pimelate, polyheptadene-pimelate, poly(propoxylated bisphenol-fumarate), poly(propoxylated bisphenol-succinate), poly(propoxylated bisphenol-adipate) and poly(propoxylated bisphenol-glutarate).

Polyester toner particles, created by the EA process are illustrated in a number of patents, such as U.S. Pat. No. 5,593,807, U.S. Pat. No. 5,290,654, U.S. Pat. No. 5,308,734 and U.S. Pat. No. 5,370,963, each of which is incorporated herein by reference in its entirety. Further examples of suitable polyester toner particles include those having sodio-sulfonated polyester resin as disclosed in a number of patents, such as U.S. Pat. Nos. 6,387,581 and 6,395,445, each of which is incorporated herein by reference in its entirety. The polyester may comprise any of the polyester materials described in the aforementioned references. As these references fully describe polyester EA toners and methods of making the same, further discussion on these points is omitted herein.

In an example of a polyester toner preparation, a resin emulsion is transferred into a reactor, such as a glass resin kettle, equipped with a temperature gauge, such as a thermal probe, and mechanical stirrer. A pigment is added into this reactor while stirring. Additionally, a wax dispersion may optionally be added for oil-less systems. The pigmented mixture is stirred and heated using an external water bath to a desired temperature, for example from about 40° C. to about 70° C., such as from about 45° C. to about 70° C. or from about 40° C. to about 65° C., at a rate from about 0.25° C./min. to about 2° C./min., such as from about 0.5° C./min. to about 2° C./min. or from about 0.25° C./min. to about 1.5° C./min. A freshly prepared solution of a coalescing agent may be made to ensure efficacy of the aggregation. Once the emulsion reaches the desired temperature, the solution of a coalescing agent is pumped into the mixture, for example through a peristaltic pump. The addition of the solution of coalescing agent is completed after, for example, from about 1 hour to about 5 hours, such as from about 1 hour to about 4 hours or from about 1.5 hours to about 5 hours, and the mixture is additionally stirred from about 1 hour to about 4 hours, such as from about 1 hour to about 3.5 hours or from about 1.5 hours to about 4 hours. The temperature of the reactor may then be raised towards the end of the reaction to, for example, from about 45° C. to about 75° C., such as from about 50° C. to about 75° C. or from about 45° C. to about 70° C., to ensure spheridization and complete coalescence. The mixture is then quenched with deionized water that is at a temperature of, for example, from about 29° C. to about 45° C., such as from about 32° C. to about 45° C. or from about 29° C. to about 41° C. The slurry is then washed and died.

Examples of styrene/acrylate resin binders include poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), and poly(alkyl acylate-acrylonitrile-acrylic acid); the latex contains a resin selected from the group consisting of poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), and poly(styrene-butyl acrylate-acrylononitrile-acrylic acid).

Styrene/acrylate toner particles created by the EA process are illustrated in a number of patents, such as U.S. Pat. Nos. 5,278,020, 5,346,797, 5,344,738, 5,403,693, 5,418,108 and 5,364,729, each of which is incorporated herein by reference in its entirety. The styrene/acrylate may comprise any of the materials described in the aforementioned references. In embodiments, the styrene/acrylate, such as styrene/butyl acrylate toner particles may include β-carboxyethylacrylate or acrylic acid. β-carboxyethylacrylate or acrylic acid may be present in the emulsion in a range from about 1 weight percent to about 10 weight percent, such as from about 2 weight percent to about 10 weight percent or from about 1 weight percent to about 8 weight percent, styrene may be present in the emulsion in a range from about 65 to about 85 weight percent, such as in a range from about 70 to about 85 weight percent or from about 65 to about 80 weight percent, and acrylate, for example butyl acrylate, may be present in the emulsion in a range from about 15 to about 35 weight percent, such as from about 20 to about 35 weight percent or from about 15 to about 30 weight percent.

EA toner formulations using a styrene/acrylate resin may be made by first homogenizing then mixing resin, a colorant, and a coagulating agent at a temperature at or above the Tg of the resin, such as 5° C. to about 50° C. above the Tg of the resin, which Tg is usually in the range of from about 50° C. to about 80° C. or is in the range of from about 52° C. to about 65° C. The mixture is grown to a desired size, such as from about 3 to about 20 microns, for example from about 4 to about 15 microns or from about 5 to about 10 microns. An outer shell, for example consisting essentially of binder resin, may then be added, for example having a thickness of about 0.1 to about 2 micron, and then growth is halted with the addition of a base. The particles are then coalesced at an elevated temperature, such as from about 60° C. to about 98° C., until a suitable shape and morphology is obtained. Particles are then optionally subjected to further processing, for example, such wet sieved, washed by filtration, and/or dried. The slurry may then be washed to remove impurities. The washing involves base addition, addition of an optional enzyme product and mixing for several hours. The toner particles are then filtered to a wet cake, reslurried with deionized water and mixed. After mixing, the slurry is dewatered, added to deionized water, pH adjusted and mixed. The pH is adjusted to be from about 3 to about 5, such as from about 3.5 to about 5 or from about 3 to about 4.5. The particles are then dewatered again and reslurried with a smaller amount of water to better disperse during the drying process. The parent toner particles are then dried using a drier and packaged. This is merely one example of an EA process, other processes include the production of polyester EA toner which may be made in a different manner.

The resin is present in various effective amounts, such as from about 70 weight percent to about 98 weight percent of the toner, and can be of small average particle size, such as from about 0.01 micron to about 1 micron in average volume diameter as measured by the Brookhaven nanosize particle analyzer.

In both polyester toner EA processes and styrene/acrylate toner EA processes, a surfactant may be added to the original resin mixture. Surfactants suitable for use herein may be anionic, cationic or nonionic surfactants in effective amounts of, for example, from about 0.01 to about 15, or from about 0.01 to about 5 weight percent of the reaction mixture.

Anionic surfactants include sodium dodecylsulfate (SDS), sodium dodecylbenzene sulfonate, sodium dodecylnaphthalene sulfate, dialkyl benzenealkyl, sulfates and sulfonates, abitic acid, available from Aldrich, NEOGEN R™, NEOGEN SC™ obtained from Kao, and the like.

Examples of cationic surfactants include dialkyl benzene alkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quatemized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, SANISOL B-50 available from Kao Corp., which consists primarily of benzyl dimethyl alkonium chloride, and the like.

Examples of nonionic surfactants include polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™.

In embodiments, in addition to the ceramic pigments disclosed herein, the toner particles may include other components such as non-ceramic pigments, dyes, waxes, charge additives, and surface additives.

Examples of waxes include functionalized waxes, paraffin waxes, carnauba waxes, Fischer Tropsch waxes, Montan waxes, microcrystalline waxes, substituted amide waxes, polymerized α-olefin waxes, silicone waxes, mineral waxes, polypropylenes and polyethylenes commercially available from Allied Chemical and Petrolite Corporation, wax emulsions available from Michaelman Inc. and the Daniels Products Company, EPOLENE N-15 commercially available from Eastman Chemical Products, Inc., VISCOL 550-P, a low weight average molecular weight polypropylene available from Sanyo Kasei K.K., and similar materials. Commercially available polyethylenes usually possess a molecular weight of from about 1,000 to about 1,500, while the commercially available polypropylenes are believed to have a molecular weight of from about 4,000 to about 5,000. Examples functionalized waxes include amines, amides, imides, esters, quaternary amines, carboxylic acids or acrylic polymer emulsion, for example JONCRYL 74, 89, 130, 537, and 538, all available from SC Johnson Wax, and chlorinated polypropylenes and polyethylenes commercially available from Allied Chemical and Petrolite Corporation and SC Johnson wax. When utilized, the wax may be present in the dye complex in an amount from about 2 weight % to about 20 weight %, such as from about 3 weight % to about 15 weight % or from about 4 weight % to about 12 weight %, of the toner.

The toner may also include known charge additives in effective amounts of, for example, from 0.1 to 5 weight percent, such as alkyl pyridiniuim halides, bisulfates, the charge control additives of U.S. Pat. Nos. 3,944,493, 4,007,993, 4,079,014, 4,394,430 and 4,560,635, which illustrates a toner with a distearyl dimethyl ammonium methyl sulfate charge additive, the disclosures of which are totally incorporated herein by reference, negative charge enhancing additives like aluminum complexes, and the like.

Surface additives that can be added to the toner compositions after washing or drying include, for example, metal salts, metal salts of fatty acids, colloidal silicas, metal oxides like titanium, tin and the like, mixtures thereof and the like, which additives are usually present in an amount of from about 0.1 to about 2 weight percent, reference U.S. Pat. Nos. 3,590,000, 3,720,617, 3,655,374 and 3,983,045, the disclosures of which are totally incorporated herein by reference. Additives include, for example, titania and flow aids, such as fumed silicas like AEROSIL R972® available from Degussa Chemicals, or silicas available from Cabot Corporation or Degussa Chemicals, each in amounts of from about 0.1 to about 2 percent, which can be added during the aggregation process or blended into the formed toner product.

The toner particles described herein exhibit improved color gamut, heat stability and lightfastness stability over time.

Color gamut refers to the entire range of perceived color that may be obtained under stated conditions (Principles of Color Technology, 2^{nd} Edition, Fred Billmeyer, Max Saltzman, John Wiley and Sons, NY, 1981). The color gamut is a certain complete subset of colors. Having a wide color gamut refers to pushing the boundaries of the subset to obtain the widest range of color possible. Color gamut is measured by an X-Rite spectrophotometer.

Heat stability refers to having the pigments not decompose when heated to the high temperatures required for making images on ceramic objects.

Lightfastness stability refers to the degree to which a pigment resists fading due to light exposure. Different pigments have different degrees of resistance to fading by light. This is reduced or eliminated by using inorganic ceramic pigments that do not degrade when exposed to light. After exposure to either sunlight or a light box, the density can be measured with an X-Rite densitometer and compared to the pre-exposure density. Lightness may also be measured with a spectrophotometer.

The toner particles described herein may be used to make archival prints that are resistant to fade over time, as well as print customized decals that can be placed on ceramics destined for firing, such as tiles, plates and other objects used in the ceramic industry. Once fired, the image created on the transferred decal is permanently incorporated into the selected ceramic by virtue of the use of the ceramic pigment.

The toner particles described herein may be applied to a ceramic substrate by any suitable method, for example, by spray coating, dip coating, via a decal or label, etc.

In further embodiments, a toner image comprising the toner particles described herein may be xerographically imaged onto an intermediate substrate, such as a decal or label. This decal or label may then be applied to the ceramic substrate. A suitable pressure is then applied to the decal or label in order to transfer the toner image from the intermediate substrate to the final ceramic substrate. Once the toner image is firmly on the ceramic substrate, the ceramic substrate may be fired, for example, in a kiln.

The toner may be printed onto a decal, such as described above, and then transferred to the ceramic substrate. Once the image has been made the decal is placed on the ceramic object and secured by an adhesive using slight pressure. The object is then heated to attach the design to the ceramic substrate.

### EXAMPLE

The pigment can be either dry powder or dispersed. The dry powder will have to be dispersed and attrited in order to obtain the correct particle size. Once adequately dispersed in water and surfactant, the pigment is added to the dispersed polymeric resin in a 2 liter glass reactor.

Additional components, that is, release agents and charge control agents, are also added for improved release and charge. An aggregating agent, that is, an aluminum salt, is added in amounts of from about 10 pph to about 25 pph.

The pre-toner particles are then heated, mixed and aggregated at or below the resin glass transition temperature (Tg) to a size of from about 5 microns to about 10 microns, then a shell of latex resin is added to mitigate any charge from the pigment. Once the appropriate size is reached, the pH is adjusted using a base, and addition of hydroxide stops the particle growth. The temperature of the mixture is then ramped to a temperature of from about 80° C. about 100° C., and coalesced at the elevated temperature.

Once the desired particle size and shape is obtained, the temperature is decreased to below the resin Tg and the washing process takes place. The aggregated and coalesced particles are washed and dried, and then blended with the appropriate additives per machine design. The toner is then taken and paced into a cartridge and printed on the preferred transfer media. The image is then taken and placed on the ceramic object and secured using adhesive or another method of attachment.

The object is heated to a temperature of from about 600° C. to about 1200° C. until sintering has taken place and the ceramic process is complete. The object is then removed from the oven and cooled. The permanent color image is created with the ceramic pigments on the substrate.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An emulsion aggregation toner particle comprising at least one binder and a colorant, wherein the colorant includes at least one ceramic pigment.

2. The emulsion aggregation toner particle according to claim 1, wherein the binder is a polymeric resin.

3. The emulsion aggregation toner particle according to claim 2, wherein the polyester resin is selected from the group consisting of polyethylene-terephthalate, polypropylene-terephthalate, polybutylene-terephthalate, polypentylene-terephthalate, polyhexalene-terephthalate, polyheptadene-terephthalate, polyoctalene-terephthalate, polyethylene-sebacate, polypropylene sebacate, polybutylene-sebacate, polyethylene-adipate, polypropylene-adipate, polybutylene-adipate, polypentylene-adipate, polyhexalene-adipate, polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate polyethylene-pimelate, polypropylene-pimelate, polybutylene-pimelate, polypentylene-pimelate, polyhexalene-pimelate, polyheptadene-pimelate, poly(propoxylated bisphenol-fumarate), polypropoxylated bisphenol-succinate), poly(propoxylated bisphenol-adipate), poly(propoxylated bisphenol-glutarate) and mixtures thereof.

4. The emulsion aggregation toner particle according to claim 2, wherein the styrene/acrylate resin is selected from the group consisting of poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), and poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylononitrile-acrylic acid), poly(styrene-butyl acrylate-β-carboxyethylacrylate) and mixtures thereof.

5. The emulsion aggregation toner particle according to claim 1, wherein the ceramic pigment is a cyan pigment, a magenta pigment a yellow pigment, a blue pigment, a red pigment, a green pigment, a white pigment, a black pigment or combinations thereof.

6. The emulsion aggregation toner particle according to claim 5, wherein the ceramic pigment is Black 444, Blue 385, Violet 11, Yellow 10P110, spinel black, iron oxide/Mars Black 318, Iron Oxide Black Bluish 306, Iron Oxide Black Brownish 320, iron glimmer gray, manganese violet, zirconium cerulean blue, cobalt blue, cobalt cerulean blue, cobalt blue greenish, cobalt turquoise, cobalt violet, cobalt green, cobalt oxide green, cobalt bottle green, cobalt light green, chrome oxide green, Mars Red light 110, Mars Red Medium 120, Mars Red 130, Mars Red 222, Indian Red, Spanish Red, titanium orange, lead-tin yellow, Priderite Yellow, nickel titanium yellow, Praseodym Yellow, cobalt yellow, intensive yellow, bismuth yellow or titanium white.

7. The emulsion aggregation toner particle according to claim 1, wherein the ceramic pigment has an average size of from about 200 nm or less.

8. The emulsion aggregation toner particle according to claim 7, wherein the ceramic pigment has an average size of from about 0.1 nm to about 150 nm.

9. The emulsion aggregation toner particle according to claim 1, wherein the ceramic pigment is from about 2 weight percent to about 18 weight percent of the toner particle.

10. The emulsion aggregation toner particle according to claim 1, wherein the ceramic pigment includes surface modification.

11. The emulsion aggregation toner particle according to claim 10, wherein the surface modification is a hydrophilic functional group.

12. The emulsion aggregation toner particle according to claim 11, wherein the hydrophilic functional group is a carboxyl group, a sulfonic acid, an amine, an amine salt or a phosphonic salt.

13. The emulsion aggregation toner particle according to claim 1, wherein the toner particle further comprises waxes, curing agents, charge additives, and/or surface additives.

14. A process for making an emulsion aggregation toner particle, comprising:
mixing a resin, a colorant, and a coagulating agent;
aggregating particles to a size of from about 3 to about 20 microns;
halting the aggregation of the particles; and
coalescing the particles, wherein the colorant comprises at least one ceramic pigment.

15. The process according to claim 14, wherein the ceramic pigment includes surface modification.

16. The process according to claim 15, wherein the surface modification is a hydrophilic functional group.

17. The process according to claim 16, wherein the hydrophilic functional group is a carboxyl group, a sulfonic acid, an amine, and amine salt or a phosphonic salt.

18. The process according to claim 14, wherein the mixing occurs at a temperature from about 50° C. to about 80° C., growth of the toner particles are halted by addition of a base, and coalescing occurs at a temperature from about 60° C. to about 98° C.

19. The process according to claim 14, wherein the mixing occurs at a temperature from about 40° C. to about 70° C. and coalescing occurs at a temperature from about 45° C. to about 75° C. and by addition of a coalescing agent.

20. A method, comprising:
applying a toner image composed of emulsion aggregation toner particles onto a ceramic substrate,
firing the ceramic substrate in order to permanently affix the toner image thereon,
wherein the emulsion aggregation toner particles comprise at least one binder and a colorant, and wherein the colorant includes at least one ceramic pigment.

21. The method according to claim 20, wherein the applying comprises forming the toner image on a decal, and subsequently applying the decal onto the ceramic substrate.

22. The method according to claim 21, wherein the decal is a transfer sheet comprising a carrier sheet, a release layer, the toner image and an adhesive layer.
